(19) United States
(12) Patent Application Publication
(10) Pub. No.: US 2007/0153557 A1
(43) Pub. Date: Jul. 5, 2007

(54) Linear AC/DC power adapters

(76) Inventor: Juan Carlos Corona Ochoa, Richmond (CA)

Correspondence Address: Michael Bednarek;Pillsbury Winthrop Shaw Pittman LLP, 1650 Tysons Boulevard, McLean, VA, 22102, US

(21) Appl. No.: 11/415,089

(22) Filed: May 2, 2006

Related U.S. Application Data
(60) Provisional application No. 60/754,620, filed on Dec. 30, 2005.

(51) Int. Cl. H02M 7/00

(52) U.S. Cl. 363/125

(57) ABSTRACT

An AC/DC power adapter comprising a transformer and a rectifier bridge. The rectifier bridge replaces the conventional diodes with Schottky diodes. Due to a low voltage drop, the heat dissipated by the rectifier bridge is decreased and the power efficiency of the rectifier bridge is significantly increased.

This application claims the benefit of U.S. Provisional Application No. 60/754,620, filed Dec. 30, 2005, which is herein incorporated by reference in its entirety.

### BACKGROUND

1. Field of the Invention

The invention relates generally to a power adapter, and more particularly, to linear AC/DC power adapters with power efficiencies.

2. Background of the Invention

A conventional linear AC/DC power adapter that is commonly used in consumer electronics such as cordless telephones includes a diode bridge composed of four conventional diodes. The use of conventional diodes contributes in reducing the adapter power efficiency, which, along with other component power consumption, fails to comply with the Appliance Efficiency Regulations promulgated by California Energy Commission. To solve the problem, one available technical option is to use switching power adapters. Such adapters, however, are expensive and may add electrical side effects to the telephone. Known side effects include, for example, noise, radiated emissions, and poor isolation between an electricity main ground and a telephone line ground.

An improved linear adapter uses a better-quality core for a transformer to reduce core losses. This improvement results in AC/AC adapters passing the California regulation, but AC/DC adapters still do not comply the regulation. Accordingly, there is still a need for an AC/DC power adapter with higher power efficiency.

### BRIEF SUMMARY OF THE INVENTION

Certain embodiments of the invention provide an AC/DC power adapter used in consumer electronics such as cordless telephones. The AC/DC power adapter replaces conventional diodes of a diode bridge with Schottky diodes. The use of Schottky diodes reduces the heat dissipation of the bridge to increase the power efficiency.

In some embodiments of the invention, an AC/DC power adapter includes a transformer for reducing the level of an input AC voltage, a rectifier bridge coupled to an output of the transformer for changing the AC voltage to DC voltage after reduced, and a filter capacitor for reducing the ripple of the voltage after rectified, wherein the rectifier bridge is composed of four Schotty diodes.

### BRIEF DESCRIPTION OF THE DRAWINGS

FIG. 1 is a electrical circuitry of an AC/DC power adapter in accordance with the present invention.

FIGS. 2-6 are tables showing experimental results.

### DETAILED DESCRIPTION OF THE INVENTION

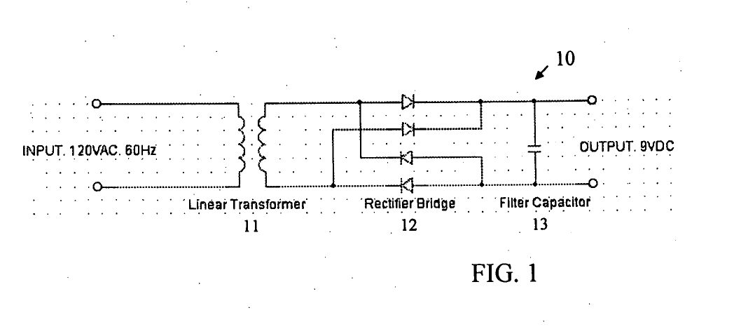

As illustrated in FIG. 1, a linear AC/DC power adapter 10 includes a linear transformer 11, a rectifier bridge 12, and a filter capacitor 13. Linear transformer 11 is used to reduce and isolate an alternating current/voltage (AC) input voltage. Rectifier bridge 12 is used to convert AC to direct current/voltage (DC). Filter capacitor 13 is used to reduce the DC voltage variations or ripple. Conventionally, the rectifier bridge is composed of four conventional rectifier diodes. Ideally, there is no energy consumption in the adapter. The energy is just transferred from the adapter input to the output. However, real adapters dissipate energy in heat form at linear transformer 11, rectifier bridge 12, and filter capacitor 13. Linear transformer 11 has energy losses due to its coil resistances and core. Rectifier bridge 12 consumes energy due to its voltage drop greater than zero. Filter capacitor 13 has contact and insulator resistance, which also dissipates heat.

Embodiments of the present invention use Schottky diodes to replace the conventional diodes of rectifier bridge 12. Schottky diodes have smaller voltage drop than conventional diodes. For example, typical voltage drop values are 0.4V for Schottky diodes and 0.7V for conventional diodes. This voltage drop reduction causes less heat dissipation on rectifier bridge 12.

The use of Schottky diodes instead of conventional diodes in Linear AC/DC power adapters improves power efficiency. It is a reliable, economic, and simple way to comply with Appliance Efficiency Regulations from California Energy Commission (CEC). Further, by using Schottky diodes, no electrical side effects occur in AC/DC power adapter 10 so that the reliability of linear adapters is maintained.

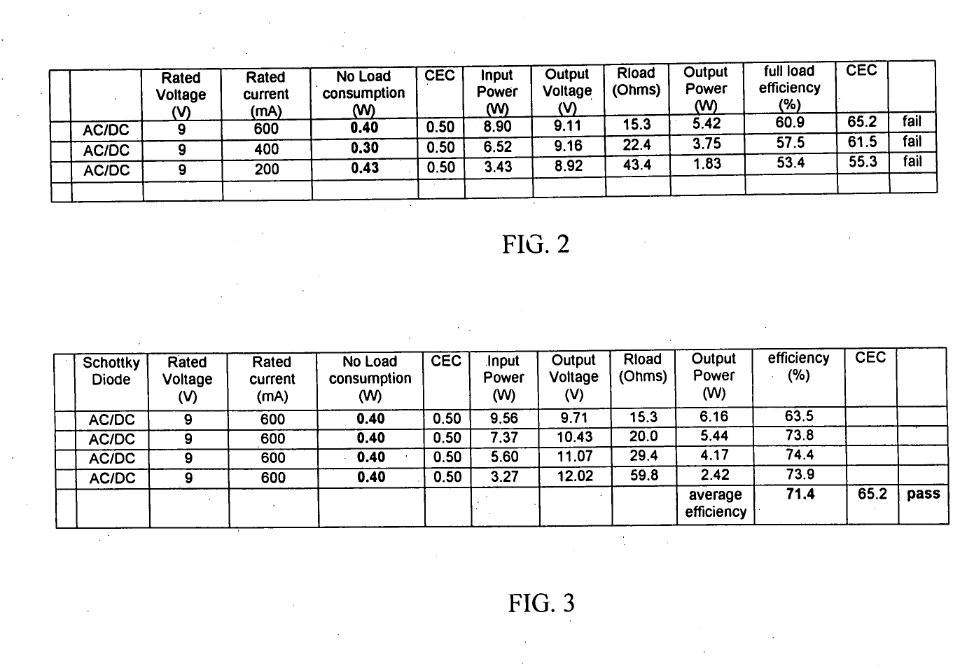

The use of Schottky is believed never been seen in linear AC/DC power adapters nor in any technical publication. Due to a smaller voltage drop of the Schottky rectifier diodes, rectifier bridge 12 composed of Schottky rectifier diodes potentially dissipates less energy than conventional rectifier diodes, as it is proved in FIGS. 2-6.

FIG. 2 shows test results of three different adapters, rated at 9 VDC 600 mA, 9 VDC 400 mA, and 9 VDC 200 mA, respectively. All of the adapters include an improved transformer core and a conventional rectifier bridge. As shown, a full load efficiency of all of them is less than a CEC average efficiency.

FIG. 3 shows test results of the same adapter rated at 9 VDC 600 mA used in the test of FIG. 2, but now with Schottky diodes in its rectifier bridge. The first row indicates the full load efficiency is 63.5% that is better than 60.9% with conventional diodes. Thus, the average efficiency is 71.4%, which is more than a required efficiency of 65.2%.

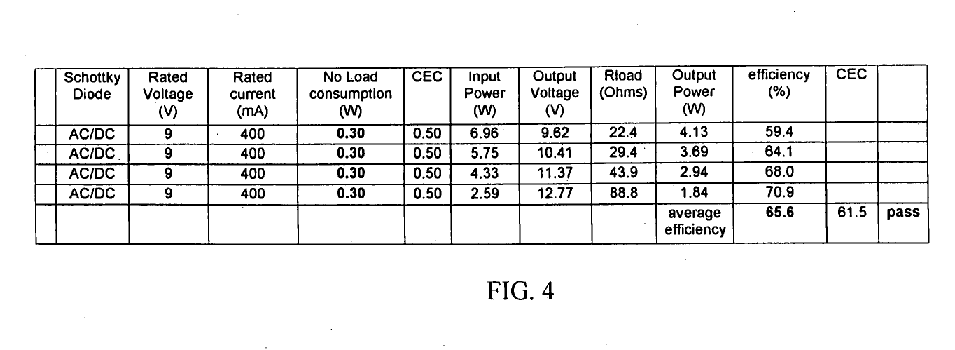

FIG. 4 shows test results of the same adapter rated at 9 VDC 400 mA used in the test of FIG. 2, but now with Schottky diodes in its rectifier bridge. The first row indicates the full load efficiency is 59.4% instead of 57.5% with conventional diodes. Thus, the average efficiency is 65.6%, which is also more than a required efficiency of 61.5%.

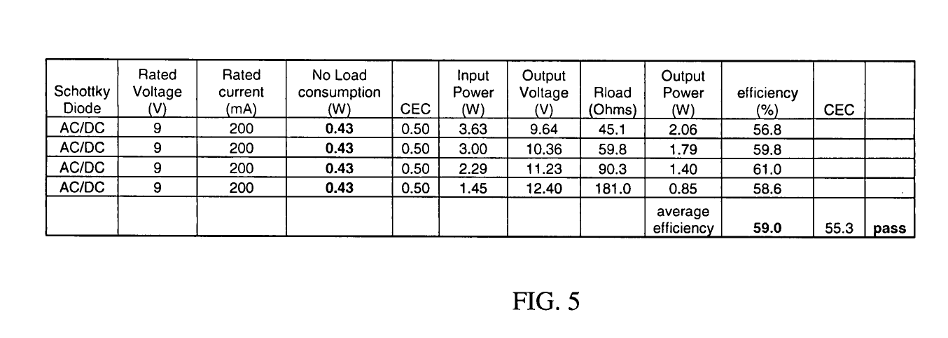

FIG. 5 shows test results of the same adapter rated at 9 VDC 200 mA used in the test of FIG. 2, but now with Schottky diodes in its rectifier bridge. The first row of the result indicates the full load efficiency is 56.8% instead of 53.4% with conventional diodes. Thus, the average efficiency is 59.0%, which is still more than a required efficiency of 55.3%.

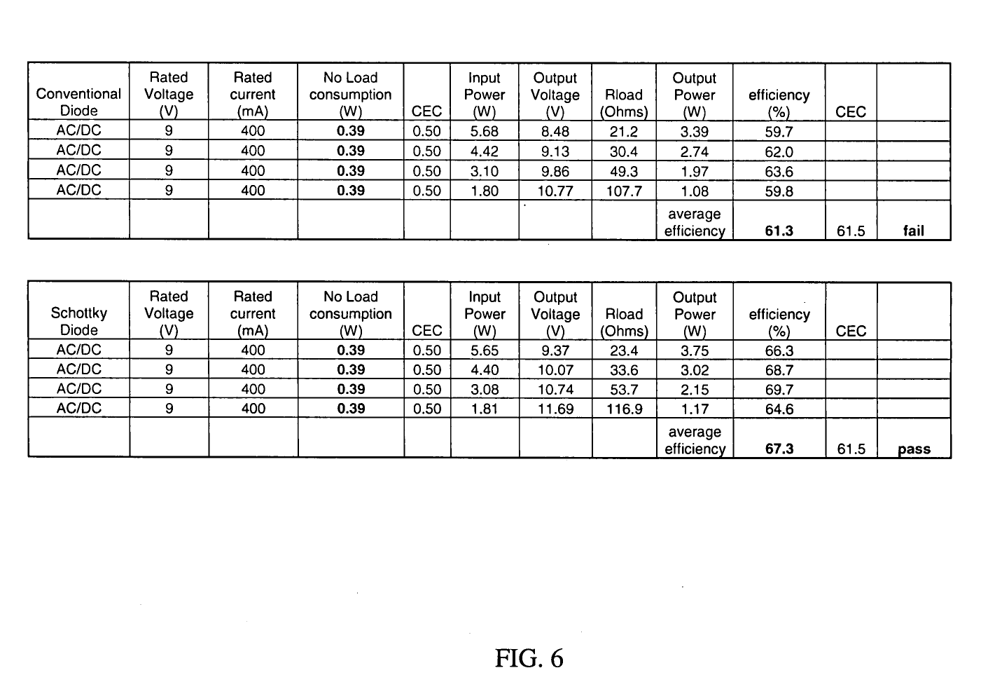

FIG. 6 shows test results of a different adapter that is rated at 9 VDC 400 mA and has an improved transformer core. As shown, the power efficiency with conventional diodes is not enough to pass CEC requirement. However, the same adapter with Schottky diodes instead of conventional diodes passes the CEC requirement with margin.

According to the present invention, AC/DC power adapters 10 has at least the following advantages:
(1) No adapter dimension changes required;
(2) Easy to manufacture;
(3) Reduce heat dissipation of a whole telephone; and
(4) No electric side effects, for example no noise added and high insulation between power main ground and telephone line ground.

Furthermore, although the rectifier bridge shown in FIG. 1 is composed of four Schottky diodes as a full wave rectifier, the number of the Schottky diodes is not limited to four. For example, the rectifier bridge can also be a half wave rectifier, in which only two Schottky is included in the rectified bridge.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. An AC/DC power adapter having an input terminal and an output terminal, comprising:
a transformer coupling to the input terminal for reducing a level of an AC voltage input; and
a rectifier bridge coupled to an output of the transformer for changing the AC voltage to an DC voltage after the AC voltage input level is reduced; and
wherein the rectifier bridge is composed of Schottky diodes.

2. The AC/DC power adapter of claim 1, further comprising a filtering capacitor coupled to the rectifier bridge for filtering the voltage after rectified.

3. The AC/DC power adapter of claim 1, wherein the output of the AC/DC power adapter is used for a consumer electronics product.

4. The AC/DC power adapter of claim 1, wherein the AD/DC power adapter is used in a cordless telephone.

5. The AC/DC power adapter of claim 1, wherein the rectifier bridge includes four Schottky diodes.

6. The AC/DC power adapter of claim 1, wherein the rectifier bridge is a full wave rectifier.

7. The AC/DC power adapter of clam 1, wherein the rectifier bridge includes two Schottky diodes.

8. The AC/DC power adapter of claim 7, wherein the rectifier bridge is a half wave rectifier.

9. The AC/DC power adapter of claim 1, has a full load efficiency in the range between about 60% and about 75% when rated at 9 VDC, 600 mA.

10. The AC/DC power adapter of claim 1, has a full load efficiency in the range between about 59% and about 71% when rated at 9 VDC, 400 mA.

11. The AC/DC power adapter of claim 1, has a full load efficiency in the range between 56% and 62% when rated at 9 VDC, 200 mA.

12. An AC/DC power adapter, comprising:
an input terminal and an output terminal;
a transformer coupling to the input terminal for reducing a level of an AC voltage input;
a rectifier bridge coupled to an output of the transformer for changing the AC voltage to an DC voltage after the AC voltage input level is reduced; and
a filtering capacitor coupled to the rectifier bridge for filtering the voltage after rectified, and
wherein the rectifier bridge is composed of Schottky diodes.

13. The AC/DC power adapter of claim 12, wherein the rectifier bridge includes four Schottky diodes.

14. The AC/DC power adapter of claim 13, wherein the rectifier bridge is a full wave rectifier.

15. The AC/DC power adapter of clam 12, wherein the rectifier bridge includes two Schottky diodes.

16. The AC/DC power adapter of claim 15, wherein the rectifier bridge is a half wave rectifier.

17. The AC/DC power adapter of claim 12, has a power efficiency in the range between about 60% and about 75% when rated at 9 VDC, 600 mA and an average power efficiency about 71%.

18. The AC/DC power adapter of claim 12, has a power efficiency in the range between about 59% and about 71% when rated at 9 VDC, 400 mA and an average power efficiency about 66%.

19. The AC/DC power adapter of claim 12, has a power efficiency in the range between 56% and 62% when rated at 9 VDC, 200 mA and an average power efficiency about 59%.

20. The AC/DC power adapter of claim 12, wherein the AC/DC power adapter is used in a cordless telephone.

21. The AC/DC power adapter of claim 12, wherein the AC/DC power adapter is used in a consumer electronics product.
